(19) United States
(12) Patent Application Publication
(10) Pub. No.: US 2008/0299407 A1
(43) Pub. Date: Dec. 4, 2008

(54) DECORATED CANDLE PIN SYSTEM

(76) Inventor: Robin Amboy, Oceanside, CA (US)

Correspondence Address: STEVEN W. WEBB, 825 College Blvd., Suite 102620, Oceanside, CA, 92057, US

(21) Appl. No.: 11/757,615

(22) Filed: Jun. 4, 2007

(51) Int. Cl. B44C 1/00; C11C 5/00

(52) U.S. Cl. 428/542.2; 29/896.4

(57) ABSTRACT

A system of making and using a candle decoration is presented, here the candle decorations are in the shape of brooches and are decorated with semiprecious stones and other decoration means. The candle decorations are attached to any candle by means of heating metallic spikes attached to the back of the decorations and inserting the spikes into the candle body.

### FIELD OF THE INVENTION

This invention relates to the field of jeweled pins, candle decorating, and candle jewelry.

### BACKGROUND OF THE INVENTION

Decorative candles in the prior art, including U.S. Pat. No. 7,144,246 to Barnstead and U.S. Pat. No. 4,225,552 to Chang, consist of candles with decorations closely married to their outer surfaces, sometimes manufactured into the candle itself. Bamstead teaches a conformal polymer ornament attached closely to the candle at manufacturing.

U.S. Pat. No. 6,669,464 to Lin, et. al., teaches a candle ornament with physical attributes to allow the decoration to remain attached to the candle while it is burning down to halfway. These and related prior art fail to teach a separately-manufactured metallic candle decoration system that is applicable to all candle shapes, can be easily inserted into any wax candle, regardless of the firmness of the wax, and is decorated with semiprecious stones.

### OBJECTS OF THE INVENTION

An object of the present invention is to provide a candle decoration that is capable of being attached to any candle surface shape.

Another object of the present invention is to provide a three-dimensional candle decoration with jewelry and other ornamentation attached.

Another object of the present invention is to provide a candle decoration that can be easily inserted into even rigid wax candles without breaking the decoration or cracking/splitting the candle.

### BRIEF DESCRIPTION OF THE DRAWINGS

FIG. 1 Perspective view of the invention attached to a candle

FIG. 2 Front view of the invention

FIG. 3. Side view of the invention

FIG. 4. Perspective view of the back of the invention

FIG. 5. Cross-section view of the invention in a candle

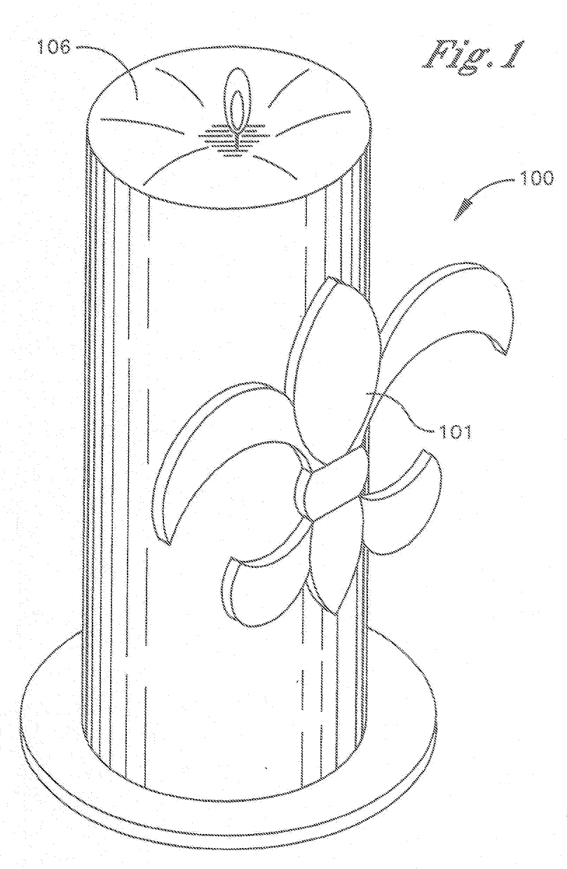

### DETAILED DESCRIPTION

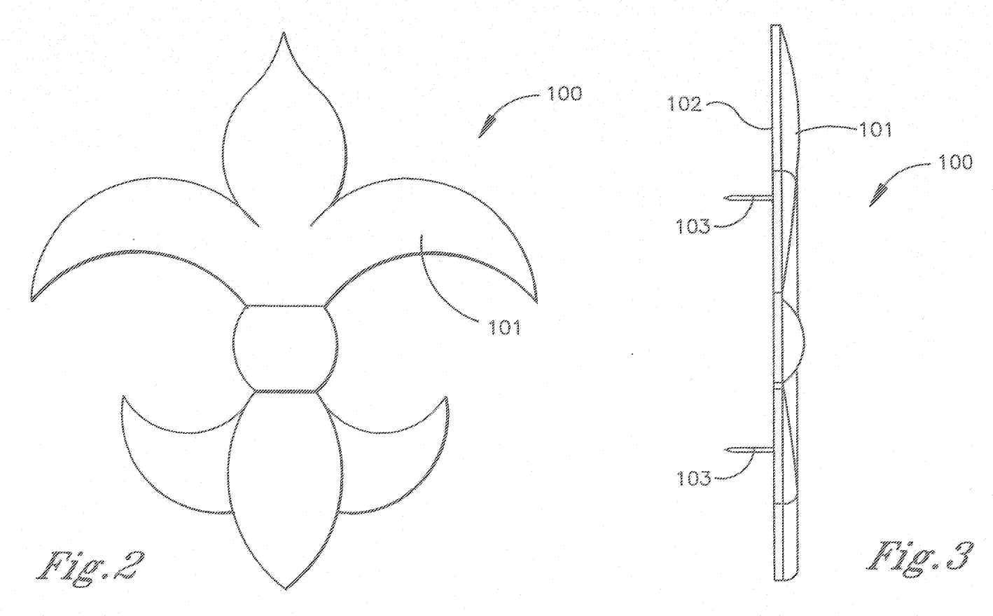

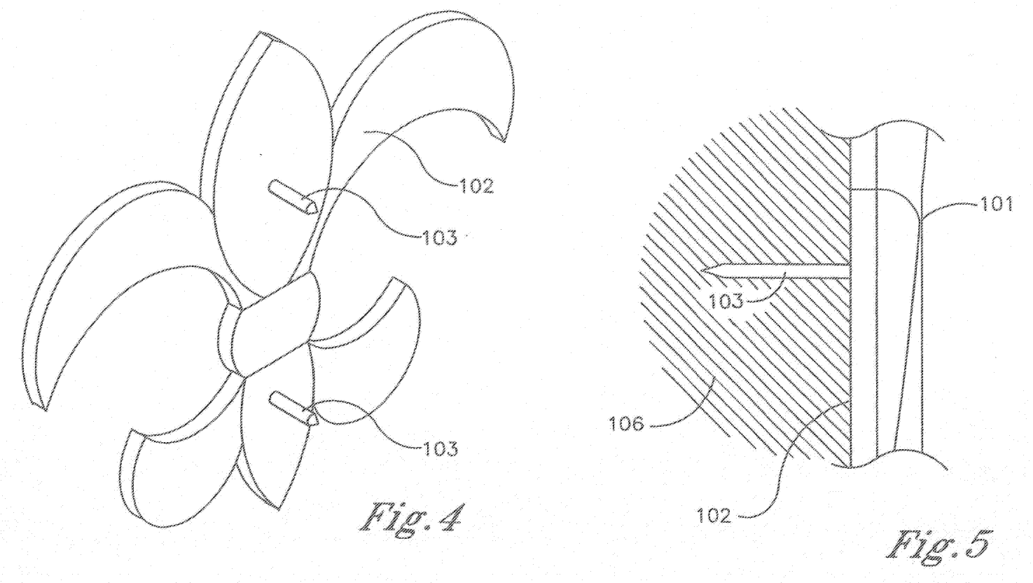

Referring to FIG. 2 and FIG. 3, the invention100 is any of a set of decorative badges or brooches, with a front surface101 possessing semiprecious stones and other ornaments applied by hand, a back surface 102 that is not decorated and is flat or concave, the back surface102 with a plurality of mounting spikes103 that are fixedly attached onto the back surface102.

The invention100 is comprised of any rigid material, including metals such as aluminum, brass, steel, tin, or pewter, or any ceramic or plastic. The invention100 is assembled by means of selecting a pre-formed decorative badge, such as the fleur-de-lis in the figures supplied, and welding, brazing or gluing a plurality of mounting spikes103 onto the back surface102.

The invention100 is used by selecting a candle106 of any shape to be decorated, heating the mounting spikes103 with a flame or other heat source, and then pushing the mounting spikes103 into the body of the candle until the back surface102 of the invention100 contacts the surface of the candle106. Note that there are two mounting spikes103 on the invention100 in the figures supplied, but more than two could be supplied, especially with larger embodiments of the invention100 and larger candles 106.

Heating the mounting spikes103 before attaching the invention100 to a candle allows the invention100 to be used with candles106 that are comprised of firm wax or other materials, or possess firm outer surfaces or coatings.

This invention has other applications, potentially, and one skilled in the art could discover these. The explication of the features of this invention does not limit the claims of this application; other applications developed by those skilled in the art will be included in this invention.

What is claimed is:

1. (canceled)

2. (canceled)

3. (canceled)

4. (canceled)

5. an improved candle decoration system, the candle decoration system comprised of
a set of decorative brooches, each brooch comprised of a rigid material with a front surface and a back surface,
the front surface possessing a plurality of ornaments attached fixedly by hand,
the back surface not decorated, the back surface possessing a plurality of mounting spikes fixedly attached onto the back surface by a spike attachment means, the mounting spikes comprised of a rigid material, the mounting spikes extending perpendicularly from the back surface,
the ornaments comprised of semiprecious stones,
the spike attachment means selected from the list of gluing, brazing, welding, and attaching with a screw means.

6. A method of manufacturing an improved candle decoration system as in claim 5, the method comprised of the steps of
selecting a pre-formed decorative brooch,
decorating the brooch with decorations selected from the list of semiprecious stones, cloisonné, lacquer, and sparkles,
selecting one or more mounting spikes comprised of a material compatible with the material of the decorative brooch,
selecting a spike attachment means from the list of welding, brazing, gluing, or screwing,
using the spike attachment means, fixedly attaching one or more mounting spikes onto the back surface of the decorative brooch.

7. A method of using an improved candle decoration system as in claim 5, the method comprised of the steps of
selecting a candle to be decorated,
selecting a decorative brooch with mounting spikes attached,
heating the mounting spikes with a heating means,
using the heating means to heat the mounting spikes to a temperature sufficient to melt candle wax or to penetrate any candle covering,
when the temperature in the previous step is reached, inserting the mounting spikes into the candle until the back surface of the decorative brooch encounters the candle surface,
allowing the candle and brooch to cool.

8. An improved candle decoration system as in claim 5 where the rigid material is selected from the list of aluminum, brass, steel, tin, pewter, plastic and ceramic.
